(19) United States
(12) Patent Application Publication
(10) Pub. No.: US 2026/0048563 A1
(43) Pub. Date: Feb. 19, 2026

(54) METHOD OF MANUFACTURING OF PACKAGING AND TABLEWARE FROM GRAIN PRODUCTS

(71) Applicant: Ruslan Syrakvasha, Gomel (BY)

(72) Inventor: Ruslan Syrakvasha, Gomel (BY)

(21) Appl. No.: 19/295,636

(22) Filed: Aug. 10, 2025

Related U.S. Application Data
(60) Provisional application No. 63/681,832, filed on Aug. 11, 2024.

(51) Int. Cl. B31D 1/00; A21D 13/48; B65D 65/46

(52) U.S. Cl. CPC B31D 1/0075; A21D 13/48; B65D 65/466; B31D 2201/00

(57) ABSTRACT

A method for manufacturing a composite material for packaging and tableware is disclosed. The method comprises forming a sheet from a grain-based composition, either by puffing the composition between matrices in a puffing chamber or by extruding a plasticized composition through a die. The resulting sheet, which has a porous matrix, is then laminated on at least one side with a protective film. Lamination may be performed using hot, cold, or wet techniques. The final laminated composite sheet, having a sandwich-type structure, can be cooled, cut into blanks, and subsequently formed into various articles such as trays, plates, and containers.

### CROSS-REFERENCE TO RELATED APPLICATIONS

This application claims the benefit of U.S. Provisional Application No. 63/681,832, filed on Aug. 11, 2024, the entire content of which is incorporated herein by reference.

### FIELD OF THE INVENTION

The present invention relates to manufacturing of biodegradable packaging and tableware from grain products for the food industry. More particularly, the invention relates to the manufacturing of products from raw grain materials through grain explosion (puffing) and extrusion, followed by lamination with various types of biodegradable and/or edible films.

### BACKGROUND

Despite the rapidly growing consumer demand for more eco-friendly finished products, the manufacturing of biodegradable packaging and containers faces key challenges in scaling up production volumes due to a lack of cost-effective biodegradable packaging materials made from various raw components. As a result, manufacturers of packaging materials are tasked with finding the most effective solutions and methods for producing biodegradable products.

As the market for biodegradable products expands, consumers demand more from packaging materials, including the ability to retain heat and/or cold, have longer lasting moisture resistance and even be edible. From the manufacturer's perspective, there is a growing need for packaging production methods characterized by availability and variability of raw materials, the capability to shape the material into various forms during production, and a high degree of biodegradability.

Currently, the assortment of raw materials used for the production of biodegradable packaging is mainly represented by paper, cardboard, and oxo-biodegradable plastic due to their wide availability. Meanwhile, grains and grain products, which are widely available and economically viable raw materials, have only been utilized within the sector of packaging products and container manufacturing.

The currently known methods for obtaining materials and/or products from grains have a number of flaws that prevent the resulting material and/or product from being used as packaging with sought-after properties, such as thermal insulation and moisture resistance, in addition to having poor organoleptic properties that would allow the final product to be identified as edible.

The combination and variety of the aforementioned packaging characteristics will determine its viability in the packaging and container production market. Therefore, in the near future, the manufacturers face the task of finding alternative solutions for the production of biodegradable products that can address issues, such as expanding the range of raw material used, and reducing material and production costs of the final product to meet the rapidly growing demand for these products.

The known methods and devices for producing popped and/or exploded grains include the following: SU 1630762A1, published on 1991 Feb. 28; SU 1630763A1, published on 1991 Feb. 28; and U.S. Pat. No. 4,844,937A, published on 1989 Jul. 4. The above-mentioned methods and devices involve loading grain into a sealed heating chamber where upon reaching a specific temperature and pressure, moisture is released from the grain. Upon opening of the chamber, the released moisture turns into steam, causing the grain to burst and ejecting it. The next portion of grain is loaded thereafter. However, these methods are limited to producing only bulk popped grains, not shaped or formed into a specific product.

Another known method involves producing products like wafers and crackers from popped grains (GB 2052240, published on 1981 Jan. 28), wherein grain is fed into a sintering chamber using a loading device consisting of a hopper and a dispenser, which includes horizontally moving clamping grippers and a tray with autonomous drive mechanisms. From the bunker, the grain travels to the heating chamber via the dispenser. The tray then moves and the grain spills onto the lower matrix, the clamping gripper opens and moves out of the chamber. During the next stage, the upper matrix and holder press the grain, heating the grain to a set temperature. Then the matrices and/or molds are quickly released to the height of the final product, causing the grain to burst, puff and bakes filling the open space. The resulting product is then pushed out by an ejector that is located on the bottom tray of the dispenser. However, this method does not guarantee consistently high-quality of the manufactured products due to a percentage of grain failing to burst and due to shape inconsistencies of the final product.

A similar method involves producing expanded grain products by feeding a dose of grain into a sintering chamber, heating and compressing the grain with matrices, and allowing the grains to burst upon rapid separation of the matrices to the desire product height. That invention relates to food processing, specifically to the processing of grain and grain mixtures into waffles, croutons, and crackers in a single operation without any additional processing. (patent for invention RU 2080085, published on 1997 May 27). This process, however, has limited technological capabilities for manufacturing of a broader range of products and does not guarantee the quality of the final product.

Known methods and devices for production of edible containers and tableware include U.S. Pat. No. 11,382,333B2 published on 2022 Jul. 12; U.S. Pat. No. 12,250,951B2 published on 2025 Mar. 18; US 2023/0189861A1, published on 2023 Jun. 15; US 2021/0259443A1, published on 2021 Aug. 26; US 2020/0196786A1, published on 2020 Jun. 25; US 2018/0192803A1, published on 2018 Jul. 12; U.S. Pat. No. 7,967,904B2, published on 2011 Jun. 28; US 2007/0148384A1, published on 2007 Jun. 28; and U.S. Pat. No. 8,382,888B2, published on 2013 Feb. 26. These methods include the creation of edible containers, tableware, and products from grains and other natural ingredients, often using extrusion, pressing, and baking. For example, US patents 2021/0259443A1 and US 2020/0196786A1 describe methods for producing edible utensils and straws from various types of flour and binding agents. These methods, however, are focused on creating individual pieces of tableware or containers, rather than producing sheets of grain products. Another shortcoming of the above-mentioned patents is the difficulty in achieving the necessary moisture resistance and mechanical strength of the product, as well as the limited technological flexibility for producing a variety of different types and shapes of products.

Known methods of manufacturing biodegradable and compostable packaging include the following known patents: US 2011/0227254A1, published on 2011 Sep. 22; U.S. Pat. No. 7,967,904B2, published on 2011 Jun. 28; US 2007/0148384A1, published on 2007 Jun. 28; and U.S. Pat. No. 8,382,888B2, published on 2013 Feb. 26. These methods include the creation of biodegradable and compostable containers and packaging from various natural ingredients, such as starch, natural fibers, and other bio-polymers. For example, patent US 2011/0227254A1 describes the production of bio foam used for forming biodegradable items. However, the disadvantages there includes limited durability and stability of the products in high humidity, as well as difficulties in achieving the desired structure and texture of the final product, and limited applicability to food products that require long-term storage in a controlled environment.

There are also known methods of extrusion and lamination of food products, such as U.S. Pat. No. 12,250,951B2 published on 2025 Mar. 18; US 2023/0189861A1, published on 2023 Jun. 15; US 2021/0259443A1, published on 2021 Aug. 26; US 2020/0196786A1, published on 2020 Jun. 25; US 2018/0192803A1, published on 2018 Jul. 12. These methods include the extrusion of food mass to create sheets and products, followed by lamination to enhance their durability and moisture resistance. For example, US patent 2021/0259443A1 describes a method for creating edible straws from extruded food mass. Disadvantages of the above-mentioned method include the uneven distribution of mass in the manufactured items, which can lead to defects in the final product, as well as limited versatility in producing items of various shapes and sizes.

The known methods of production of edible packaging materials (US 2011/0227254A1, published on 2011 Sep. 22; U.S. Pat. No. 7,967,904B2, published on 2011 Jun. 28; US 2007/0148384A1, published on 2007 Jun. 28; U.S. Pat. No. 8,382,888B2, published on 2013 Feb. 26) include the creation of edible packaging materials from natural ingredients, such as starch and bio-polymers, for packaging various food and non-food items. For example, US patent 2011/0227254A1 describes the creation of biodegradable packaging from bio foam. Disadvantages here include poor durability of the packaging materials when subjected to high humidity and their limited ability to protect packaged products from the elements.

The most analogous and closely related method involves producing a cup from grain by extruding a strip of expanded grain product via extrusion and boiling, rolling the above-mentioned strip into a sheet between rollers, cutting it into blanks or preforms, and forming the blanks into a conical shape (RU 2307509, published on 2007 Oct. 10)—prototype. However, this method has limited utility with regard to producing a wide range of flat, rectangular items with high porosity, in addition to challenges with uniform mass distribution, and moisture resistance and/or waterproofing.

Despite the known methods for producing grain-based packaging and edible containers, there remains an unmet need for a manufacturing process that enables the continuous production of biodegradable trays and tableware from extruded or puffed grain sheets, ensuring uniform mass distribution, enhanced porosity, improved moisture resistance, and adaptability for shaping into various rigid forms. Furthermore, the process must allow compatibility with edible or biodegradable film coatings and support scalable, cost-effective implementation using common grain types and by-products.

### BRIEF SUMMARY OF THE INVENTION

The present invention provides a method for manufacturing a composite material and articles therefrom, the articles being suitable for biodegradable and/or edible packaging and tableware. The method is based on a continuous process comprising the steps of forming a grain-based sheet, laminating the sheet with a protective film, and subsequently forming the laminated sheet into a desired article. The invention combines techniques of grain expansion (via a puffing chamber or an extruder) with film lamination and thermoforming to produce articles with enhanced structural and functional properties.

The technical result of the invention is the production of flat sheets with uniform mass distribution and increased porosity in a layered “sandwich” structure. The application of biodegradable and/or edible coatings or films to the porous surface of the puffed or extruded grain product improves its resistance to moisture and mechanical deformation. This combination increases the product's shelf life, thermal insulation, and suitability for food-contact use. The method is both economical and environmentally safe.

The process includes forming the sheet from grain material by either: (i) puffing grain in a puffing chamber using heated compression and sudden matrix separation; or (ii) extruding a homogeneous grain paste under heat and pressure through a forming die. The resulting sheet is laminated on one or both sides with protective film using one of several lamination techniques-hot lamination with heated rollers, cold lamination with adhesive, or wet lamination with subsequent thermal pressing. The laminated sheet is then cooled, cut into blanks, and processed through thermal bonding and border forming to produce rigid, functional items.

The final products may include trays, dishes, insulated containers, folding boxes, and tableware such as plates, bowls, cups, and salad bowls. Suitable films include collagen, protein-zein, starch-based, gelatin, or pectin films. These coatings provide barrier properties that allow the grain-based items to resist moisture and maintain structural integrity while remaining biodegradable or edible after use.

### BRIEF DESCRIPTION OF THE DRAWINGS

The accompanying drawings, which are incorporated in and constitute a part of this specification, illustrate embodiments of the invention and, together with the description, serve to explain the principles of the invention:

FIG. 1 is a flowchart illustrating the steps of the manufacturing method.

FIG. 2 is a perspective view of a manufacturing line for producing grain-based articles.

FIG. 3 is a perspective view of an extrusion die used for forming continuous sheets from grain material.

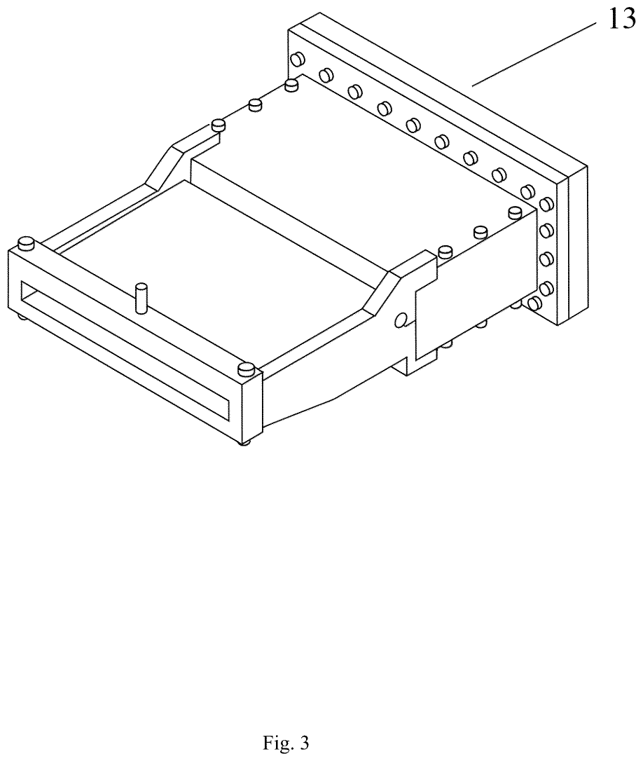

FIG. 4 is a cross-sectional view of a laminated composite (sandwich-type) sheet.

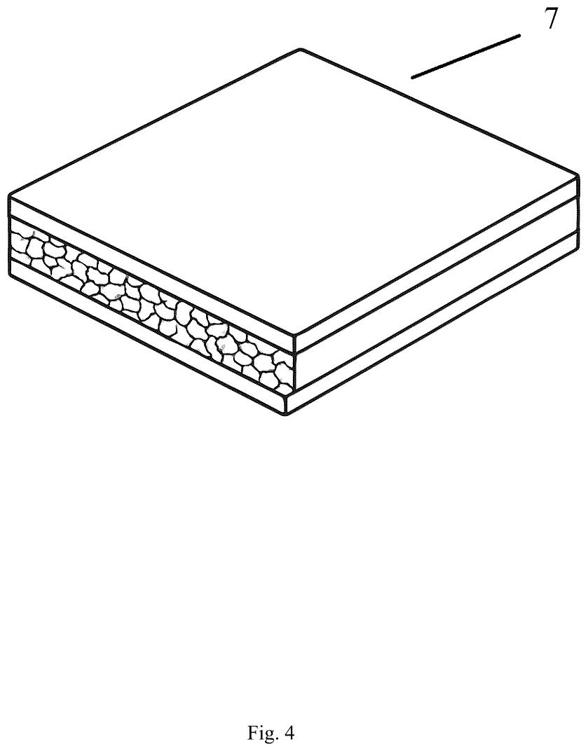

FIG. 5 is a perspective view of a final product, such as a food container, made from an expanded and laminated grain sheet.

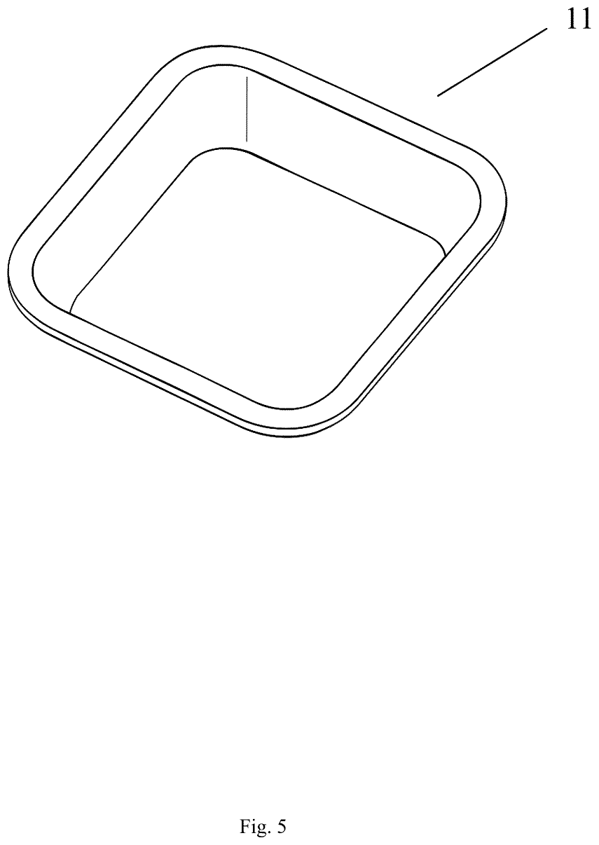

(Note: The figures are for illustration of examples and are not necessarily drawn to scale. Like reference numbers indicate like elements across figures.)

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed elements. The singular forms “a,” “an,” and “the” include plural referents unless the context clearly dictates otherwise. Furthermore, the terms “comprises” and “comprising,” as used herein, specify the presence of stated features, steps, operations, elements, or components, but do not preclude the presence or addition of one or more other features, steps, operations, elements, components, or groups thereof.

Unless otherwise defined, all technical and scientific terms used herein have the meaning commonly understood by one of ordinary skill in the art to which this invention belongs. Descriptive terminology is intended to illustrate, not limit, the invention. Terms expressed in commonly used or dictionary form should be interpreted consistently with the context of the relevant art and this disclosure, and not in an idealized or overly formal sense unless explicitly stated otherwise.

It is understood that a number of process steps, configurations, and techniques are described herein. Each such step or technique may have independent utility and may also be used in conjunction with one or more of the others. For the sake of clarity and conciseness, not every possible combination of elements or steps is repeated herein. Nevertheless, the invention should be interpreted as encompassing all such combinations and sub-combinations that yield the described benefits. The claims and specification should be construed with this understanding.

The present disclosure provides examples of new methods for manufacturing products from raw grain materials through grain explosion (puffing) and extrusion, followed by lamination with biodegradable and/or edible films. Numerous specific examples and variations are described to promote a complete understanding of the invention. However, it will be understood by those skilled in the art that the invention can be practiced without some of these specific details. In certain cases, well-known processes and structures are not described in detail to avoid obscuring the invention.

The embodiments set forth below are presented by way of illustration and are not intended to limit the invention to the specific forms disclosed. The scope of the invention is defined by the appended claims. Any directional or orientation-based references (e.g., “top,” “bottom,” “horizontal,” “vertical”) refer to the positions shown in the figures and are not intended to be limiting in a real-world use context.

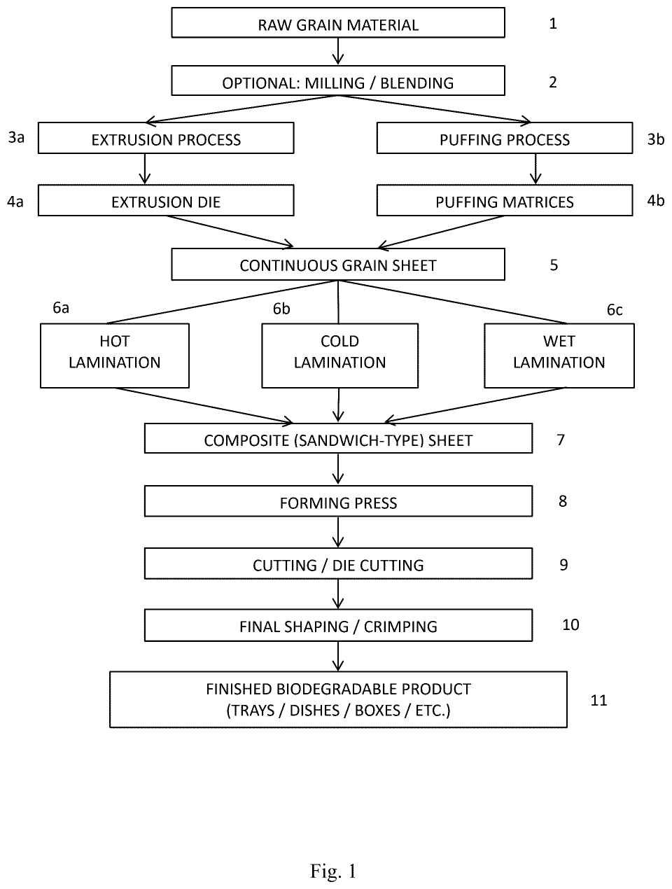

FIG. 1 is a flowchart illustrating the primary steps of the manufacturing method. The process begins with providing a raw grain material (1). This material may optionally be milled or blended (2) to achieve a desired consistency. Subsequently, a continuous grain sheet (5) is formed using one of two alternative processes: an extrusion process (3a) utilizing an extrusion die (4a), or a puffing process (3b) utilizing puffing matrices (4b). The resulting continuous grain sheet (5) is then laminated to form a composite, sandwich-type sheet (7). This lamination can be performed using one of several techniques, including hot lamination (6a), cold lamination (6b), or wet lamination (6c). Following lamination, the composite sheet (7) undergoes further processing, which includes passing through a forming press (8), cutting or die cutting (9), and a final shaping or crimping step (10) to produce the finished biodegradable product (11), such as trays, dishes, or boxes.

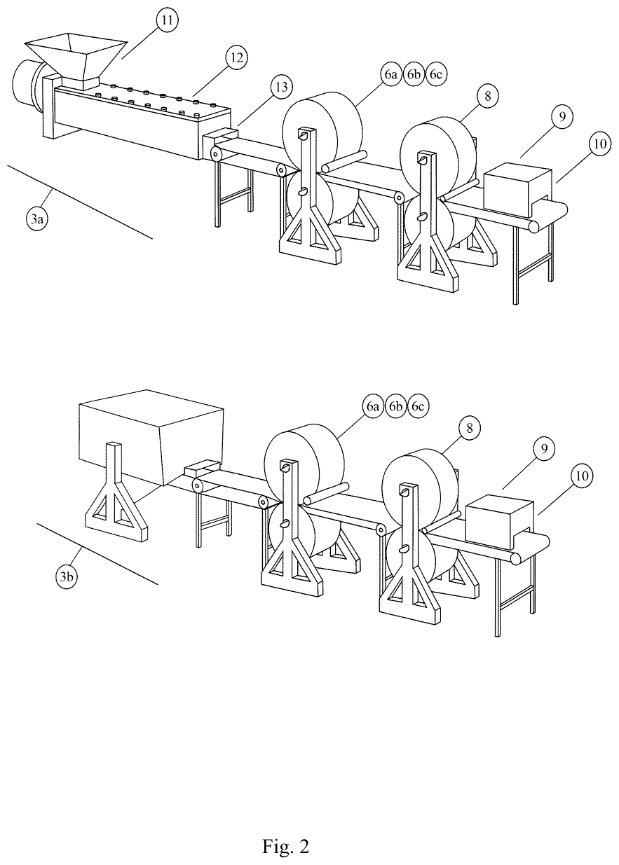

The present invention is further illustrated with reference to the accompanying figures, which depict illustrative but non-limiting embodiments. FIG. 2 shows an example of a manufacturing line for producing packaging and containers from grain-based materials. In implementing the method, various types of grain raw materials may be used, including, but not limited to: wheat, rye, barley, oats, corn, millet, and corresponding milled groats. The selection or combination of specific grain types may impart desired structural, functional, or sensory properties to the final product. The specific ratios of these components can be varied widely, and the following compositions are provided as illustrative examples only and are not intended to be limiting. In one such illustrative embodiment, the grain-based composition may comprise a mixture of 60-70% corn and 30-40% wheat by weight, wherein the corn component primarily promotes expansion and the wheat component primarily provides structural integrity. In another illustrative embodiment, the composition may include approximately 50% wheat, 30% corn, and 20% flaxseed cake by weight to improve the final product's texture and cost-efficiency.

In one embodiment, whole or milled grains having an initial moisture content are introduced into an extruder (3a), passing through a feeder (11) into the processing chamber (12). If necessary, water may optionally be added into the chamber via the feeder to achieve a target moisture content suitable for extrusion. Inside chamber (12), the grain mixture is subjected to mechanical grinding and mixing, followed by heat and pressure treatment to transform it into a homogeneous cooked paste. The specific operational parameters, such as temperature and pressure, can be adjusted by a person skilled in the art to suit the specific grain composition and desired output. The extruder may be configured to maintain the required temperature and pressure automatically. The processed mass is advanced through the extruder by a rotating helical screw and directed toward the outlet.

In an alternative embodiment, the grain may be expanded using a puffing or “grain explosion” method. A measured dose of grain is introduced into a sealed puffing chamber (heated mold) (3b) where it is heated and compressed between opposing matrices. Upon rapid separation of the matrices, the sudden pressure drop causes the grain to puff, directly forming a porous, expanded grain sheet. Thus, depending on the selected processing method, the continuous sheet of grain product is obtained as follows: (a) In the extrusion method, the processed material is forced through an extrusion die (13) forming a continuous sheet with smooth or slightly textured surfaces, uniform porosity, and consistent thickness. (b) In the puffing method, the expanded grain structure is formed directly between the matrices into a sheet having a porous texture and consistent thickness without subsequent extrusion through a die. In both cases, the resulting continuous sheet is then conveyed forward by transport rollers (6a,6b,6c).

Subsequent to the formation of the grain sheet, a protective film, which may be edible and/or biodegradable, is laminated onto at least one surface of the sheet to form a composite material, referred to herein as a ‘sandwich-type’ structure. In a preferred embodiment, the film is applied to both the upper and lower surfaces of the grain sheet. A variety of lamination techniques may be employed:

Hot Lamination: In one embodiment, gelatin-, collagen-, or pectin-based films are preferably used with hot lamination due to their thermally activated adhesion properties. The heated rollers (6a,6b,6c) press and activate the film to achieve a firm bond with the grain substrate. The heated rollers (6a,6b,6c) may operate at a surface temperature and pressure sufficient to activate the film's adhesive properties. For example, a surface temperature of 100-150° C. and an applied pressure of 0.5-2 MPa have been found effective for certain films. It is understood that these parameters are illustrative and can be adjusted depending on the specific materials used. In one illustrative, non-limiting example, it is contemplated that a sheet comprised predominantly of corn grain may be laminated using a hot lamination process with a gelatin-based film. This combination is believed to be particularly suitable for applications requiring enhanced adhesion and moisture resistance, for instance, when the final article is intended for contact with hot food items.

Cold Lamination: In another embodiment, protein-zein or protein-lipid films may be applied using cold lamination. A food-grade adhesive is applied to either the film or the sheet prior to pressing. The materials are then passed between rollers under pressure to achieve secure adhesion without heat. This method is particularly suitable for films that are heat-sensitive or require adhesive interlayers.

Wet Lamination: In yet another embodiment, lamination is performed by applying the film in liquid form (e.g., starch, gelatin, or wax solutions) via spraying or spreading onto the grain sheet. After application, the sheet is dried (e.g., with warm air or infrared drying) and optionally passed through a heated press to ensure uniformity and bonding. The coating may penetrate into the pores of the grain matrix, enhancing integration and durability.

After lamination, the composite sheet (7) proceeds to a forming press (8), where it may be hot-pressed into a desired three-dimensional shape. In one embodiment, a thermoforming mold may be used to simultaneously cut and shape the product. The pressed blanks or preforms may be transferred to a conveyor for further processing.

In one implementation, a die cutter (9) may be used to cut the laminated material into flat blanks either before or after forming, depending on the desired product geometry.

In certain embodiments, final assembly involves joining multiple preforms using thermal bonding methods such as heat sealing or edge welding (10). A roller or crimping tool may be applied along the perimeter to form a border or rim, which adds rigidity and protects the laminated edge from delamination.

The resulting products may include biodegradable and/or edible packaging items such as trays, dishes, insulated boxes, pizza boxes, or other food containers (11). These products are particularly suitable for use in HoReCa (Hotel/Restaurant/Catering) environments or fast-food service.

Additionally, the final products may include biodegradable and/or edible tableware, such as plates, bowls, cups, or salad bowls, which may be used for serving or storing hot and/or cold foods and beverages.

The embodiments described herein are illustrative and are not intended to limit the scope of the invention, which is defined by the appended claims.

What is claimed is:

1. A method of manufacturing a composite material, the method comprising: (a) forming a sheet comprising a porous grain matrix, wherein said forming is accomplished by a process selected from the group consisting of: (i) puffing a grain composition within a sintering chamber by heating and compressing the composition between matrices and subsequently rapidly separating the matrices; and (ii) extruding a plasticized grain composition through a sheet-forming die; and (b) laminating at least one surface of the sheet with a protective film.

2. The method of claim 1, wherein the protective film is laminated onto both an upper surface and a lower surface of the sheet to form a sandwich-type structure.

3. The method of claim 1, wherein the laminating is selected from the group consisting of hot lamination, cold lamination, and wet lamination.

4. The method of claim 1, further comprising the step of forming the laminated sheet into an article of tableware or packaging.

5. A composite material for manufacturing tableware or packaging, the material comprising: a core layer comprising a porous matrix of an expanded grain composition; and at least one protective film layer laminated to a surface of the core layer.

6. The composite material of claim 5, wherein the article is selected from the group consisting of a tray, a dish, an insulated box, a plate, a bowl, and a cup.

7. The composite material of claim 5, wherein the protective film is a food-grade biodegradable or edible film.

8. The composite material of claim 7, wherein the film is selected from the group consisting of a collagen-based film, a protein-zein-based film, a starch-based film, a gelatin-based film, and a pectin-based film.

9. The method of claim 1, wherein the grain composition comprises a mixture of corn and wheat.

10. The method of claim 1, wherein the grain composition comprises a mixture of wheat, corn, and flaxseed cake.

11. The composite material of claim 5, wherein the expanded grain composition comprises a mixture of corn and wheat.
